(19) United States
(12) Patent Application Publication
(10) Pub. No.: US 2012/0221863 A1
(43) Pub. Date: Aug. 30, 2012

(54) AUTHENTICATION SYSTEM

(75) Inventors: Koji OSAKA, Tokyo (JP); Shuzo Fujioka, Tokyo (JP)

(73) Assignee: Renesas Electronics Corporation

(21) Appl. No.: 13/369,103

(22) Filed: Feb. 8, 2012

(30) Foreign Application Priority Data
Feb. 24, 2011 (JP) 2011-038437

(51) Int. Cl. G06F 21/00

(52) U.S. Cl. 713/189

(57) ABSTRACT

The present invention aims to provide an authentication system that can accurately identify a genuine product. In an authentication system, a host instructs an authentication chip master to start authentication. In conjunction with the authentication start execution instruction, the host instructs a timer counter to start timer counting. In response to the authentication start execution instruction from the host, the authentication chip master outputs a challenge code to an authentication chip slave. The authentication chip slave performs an encryption process with respect to the challenge code. Then, the authentication chip slave outputs a response code obtained as the result of the encryption process, to the authentication chip master. Then, the authentication chip master performs a response code matching process, and outputs the authentication result to the host. In response to the authentication result, the host stops timer counting, and performs a verification process to accurately identify the genuine chip.

### CROSS-REFERENCE TO RELATED APPLICATIONS

The disclosure of Japanese Patent Application No. 2011-38437 filed on Feb. 24, 2011 including the specification, drawings and abstract is incorporated herein by reference in its entirety.

### BACKGROUND

The present invention relates to an authentication system, and more particularly, to an authentication between integrated circuit (IC) chips.

With the recent proliferation of networks, encryption technology and authentication technology are generally used to increase security in data transfer between devices through networks. There are various methods used for this purpose (Japanese Unexamined Patent Publication No. 2001-101107, Japanese Unexamined Patent Publication No. 2004-248270, and Japanese Unexamined Patent Publication No. 2007-336558).

However, the authentication process is not limited to the relation between devices coupled through networks. It is also general that the authentication process is performed in the case in which a body device is coupled to a part device that operates in conjunction with the body device. For example, Japanese Unexamined Patent Publication No. 2007-109444 discloses a method of performing authentication process between a battery charger and a battery pack. This authentication process can distinguish the genuine from the fake to establish an adequate control.

Patent document 1: Japanese Unexamined Patent Publication No. 2001-101107
Patent document 2: Japanese Unexamined Patent Publication No. 2004-248270
Patent document 3: Japanese Unexamined Patent Publication No. 2007-336558
Patent document 4: Japanese Unexamined Patent Publication No. 2007-109444

### SUMMARY

However, when the authentication chip for performing the authentication process included in the particular device is analyzed, it may not be possible to simply distinguish whether the particular authentication chip is the genuine chip or fake one, only based on the determination of whether the authentication process is successful or not. In this case, there may be a possibility to emulate it by software using a general-purpose microcomputer, instead of using the genuine authentication chip.

The present invention has been made to solve the above problem, and aims to provide an authentication system that can accurately identify the genuine product.

According to an embodiment of the present invention, there is provided an authentication system including a body chip, and a sub chip coupled to the body chip to perform an authentication process with the body chip. The sub chip includes a first encryption processing unit. The first processing unit performs an encryption process multiple times in response to an authentication execution instruction from the body chip, and then outputs the result to the body chip. The body chip includes an authentication determination unit. The authentication determination unit determines whether the sub chip is valid, based on the result of the encryption process from the sub chip, and on the time from the authentication execution instruction until the result is obtained.

According to an embodiment of the present invention, the authentication determination unit determines whether the sub chip is valid, not only based on the result of the encryption process but also on the time from the authentication execution instruction until the particular result is obtained. Thus, it is possible to accurately identify the genuine product.

### BRIEF DESCRIPTION OF THE DRAWINGS

FIG. 1 is a schematic diagram of an authentication system according to a first embodiment of the present invention;

FIG. 2 is a sequence diagram of the flow of an authentication process in the authentication system according to the first embodiment of the present invention;

FIG. 3 is a flowchart of a verification process according to the embodiment of the present invention;

FIG. 4 is a diagram showing the authentication system with a fake chip as a comparative example;

FIGS. 5A and 5B are diagrams showing the comparison of the authentication process time with the difference between an authentication chip slave (genuine) 20 and an authentication chip slave (fake) 30 according to the embodiment of the present invention;

FIGS. 6A and 6B are conceptual diagrams each showing an encryption process method according to the embodiment of the present invention;

FIG. 7 is a sequence diagram of the flow of the authentication process in an authentication system according to a first variation of the first embodiment of the present invention;

FIG. 8 is a sequence diagram of the flow of the authentication process in an authentication system according to a second variation of the first embodiment of the present invention;

FIG. 9 is a schematic diagram of an authentication system according to a second embodiment of the present invention; and

FIG. 10 is a sequence diagram of the flow of the authentication process in the authentication system according to the second embodiment of the present invention.

### DETAILED DESCRIPTION

Hereinafter, embodiments of the present invention will be described in detail with reference to the accompanying drawings. The same or similar parts are denoted by the same reference numerals throughout the drawings and the description thereof will not be repeated.

### First Embodiment

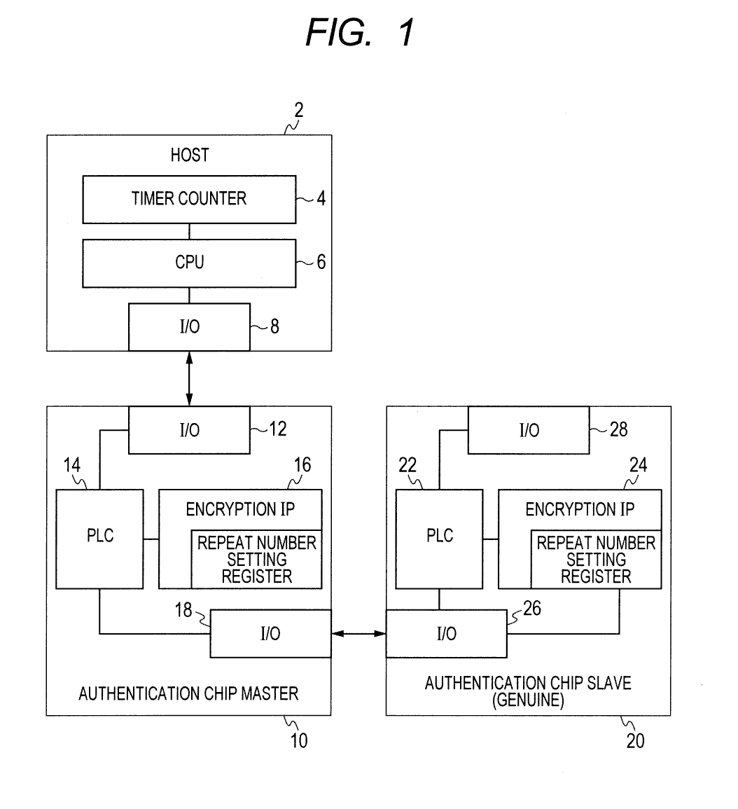

FIG. 1 is a schematic diagram of an authentication system according to a first embodiment of the present invention.

Referring to FIG. 1, the authentication system according to the first embodiment of the present invention includes a host 2, an authentication chip master 10, and an authentication chip slave 20.

The host 2 controls the entire authentication system. More specifically, the host 2 instructs the authentication chip master 10 to perform an authentication process between the authentication chip master 10 and the authentication chip slave (genuine) 20.

For example, the host 2 and the authentication chip master 10 are provided in the body device, while the authentication chip slave (genuine) 20 is provided in the component device.

When the component device is loaded to the body device, a communication path is established between the authentication chip master 10 and the authentication chip slave 20.

The host 2 includes a timer counter 4 for measuring time, a central processing unit (CPU) 6 for controlling the entire host 2, and an I/O 8 which is an interface for transferring data between the host 2 and the other device. The timer counter 4 and the I/O 8 are coupled to the CPU 6, respectively.

The authentication chip master 10 includes a programmable logic controller (PLC) 14, I/Os 12 and 18, and an encryption intellectual property (IP) 16. The IOs 12, 18 and the encryption IP 16 are coupled to the PLC 14, respectively. The PLC 14 is designed to function as a controller to control the authentication chip master 10. The I/O 12 is coupled to the I/O 8 and transfers data between the host 2 and the authentication chip master 10. The I/O 18 is coupled to an I/O 26 and transfers data between the authentication chip master and the authentication chip slave (genuine) 20. The encryption IP 16 is designed to be able to perform a predetermined encryption process multiple times.

The authentication chip slave 20 includes a PLC 22, I/Os 26 and 28, and an encryption IP 24. The IOs 26, 28 and the encryption IP 24 are coupled to the PLC 22, respectively. The PLC 22 is designed to function as a controller to control the authentication chip slave 20. The I/O 26 is coupled to the I/O 18 and transfers data between the authentication chip slave 20 and the authentication chip master 10. The encryption IP 24 is designed to be able to perform a predetermined encryption process multiple times.

In this embodiment, as an example, it is assumed that the authentication chip master 10 and the authentication chip slave 20 are configured by the same hardware, and thus are configured as the same chip.

Although not shown, a PLC design circuit is provided to design PLC contents. It is assumed that two PLC contents are set by the PLC design circuit, one of which is for the authentication chip master and the other for the authentication chip slave.

The use of the same chip has the advantage that the cost of the authentication chip is reduced and the design time is also reduced.

In this embodiment, as an example, the authentication chip master 10 and the authentication chip slave 20 are the same chip as hardware. However, the present invention is not necessarily limited to this configuration. It is also possible that the authentication chip master 10 and the authentication chip slave 20 are configured as independent chips. More specifically, the component of the I/O 28 is not specifically provided in the authentication chip slave 20.

This is the same for the host 2 and the authentication chip master 10. In other words, the host 2 and the authentication chip master 10 can be configured as the same chip or as independent chips. More specifically, if they are configured as the same chip, both the component of the I/O 8 of the host 2, and the component of the I/O 12 of the authentication chip master 10 may not be specifically provided.

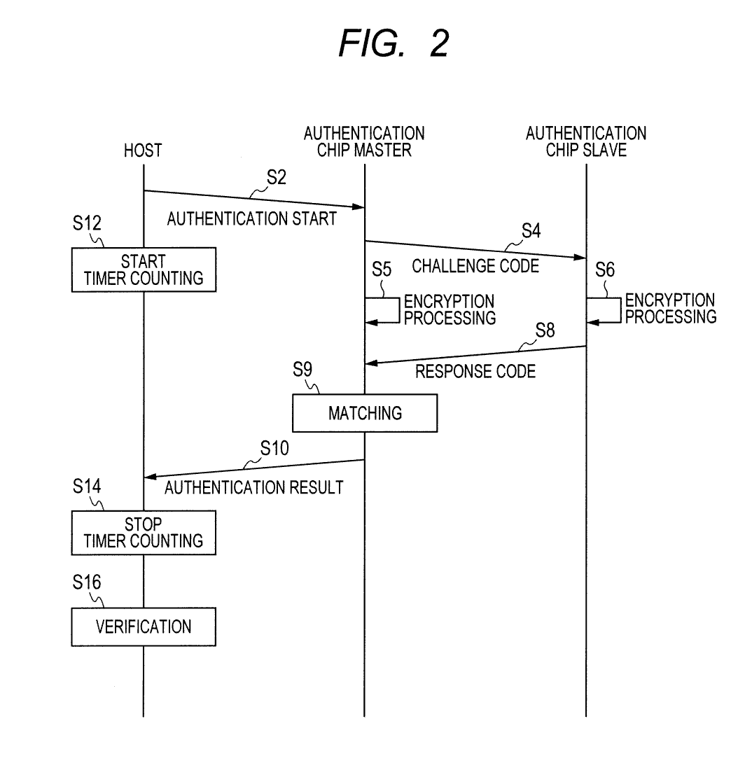

FIG. 2 is a sequence diagram of the flow of an authentication process in the authentication system according to the first embodiment of the present invention.

Here, the authentication process based on a challenge and response mechanism using an encryption process will be described.

Referring to FIG. 2, the host 2 instructs the authentication chip master 10 to start authentication (sequence S2). More specifically, the CPU 6 instructs the PLC 14 of the authentication chip master 10 through the I/O 8 to execute the authentication start.

Further, in conjunction with the authentication start execution instruction, the CPU 6 of the host 2 instructs the timer counter 4 to start timer counting (sequence S12). In this way, the execution time of the authentication process is measured.

In response to the authentication start execution instruction from the host 2, the PLC 14 of the authentication chip master 10 outputs a challenge code to the authentication chip slave 20 (sequence S4). As an example, the challenge code may be selected from random numbers or may be fixed in advance.

Next, the authentication chip slave 20 performs an encryption process with respect to the challenge code received from the authentication chip master 10 (sequence S6). More specifically, the PLC 22 of the authentication chip slave 20 receives the challenge code output from the authentication chip master 10 through the I/O 26. Then, the PLC 22 outputs the challenge code to the encryption IP 24. The encryption IP 24 performs a predetermined encryption process multiple times with respect to the challenge code output from the PLC 22.

Then, the authentication chip slave 20 outputs a response code obtained as the result of the encryption process to the authentication chip master 10 (sequence S8). More specifically, the PLC 22 outputs the result (response code) of the encryption process performed in the encryption IP 24, to the authentication chip master 10 through the I/O 26.

At the same time, the authentication chip master 10 performs an encryption process with respect to the challenge code (sequence S5). More specifically, the PLC 14 outputs the challenge code to the encryption IP 16. Then, the encryption IP 16 performs a predetermined encryption process multiple times with respect to the challenge code.

Then, the authentication chip master 10 performs a response code matching process (sequence S9). More specifically, the PLC 14 compares the response code output from the authentication chip slave 20 as the result of the encryption process performed in the encryption IP 24 with respect to the challenge code, with the result (response code) of the encryption process performed in the encryption IP 16 with respect to the challenge code. Then, the PLC 14 determines whether the two response codes match or not.

Then, the authentication chip master 10 outputs the authentication result to the host 2 (sequence S10). More specifically, the PLC 14 outputs the determination result of either match or not match to the CPU 6 of the host 2.

In response to the authentication result from the authentication chip master 10, the CPU 6 stops timer counting (sequence S14). More specifically, the CPU 6 instructs the timer counter 4 to obtain the counter value which is the authentication process time from the start of the execution of the authentication process until the authentication result is obtained.

Then, the CPU 6 performs a verification process (sequence S16). More specifically, the CPU 6 checks whether the authentication chip slave 20 is genuine or not, based on the authentication result and the authentication process time.

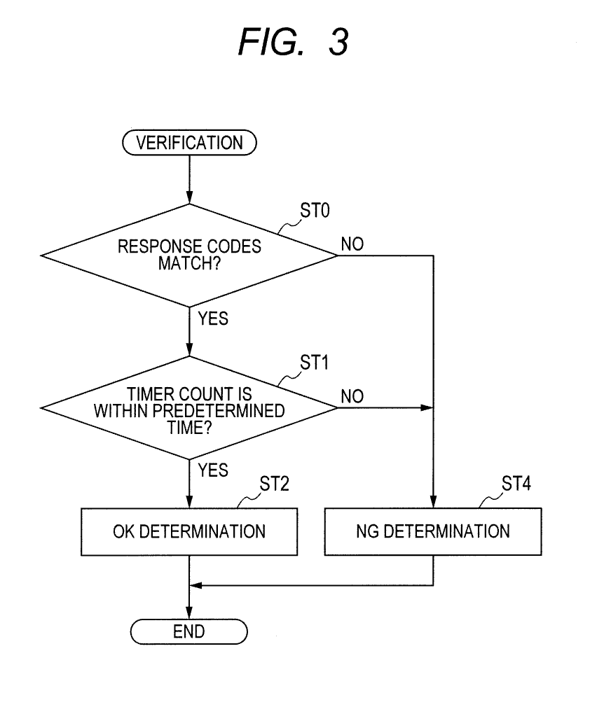

FIG. 3 is a flow chart of the verification process according to the embodiment of the present invention. Referring to FIG. 3, the CPU 6 determines whether the two response codes match or not (step ST0). If they do not match, the CPU 6 determines that the verification result is NG (step ST4).

On the other hand, if it is determined that the response codes match (YES in step ST0), then the CPU 6 determines whether the timer count is within a predetermined time (step ST1).

In step ST1, if it is determined that the timer count is within the predetermined time (YES in step ST1), the CPU 6 determines that the verification result is OK (step ST2). Then, the CPU 6 ends the process (END).

On the other hand, if it is determined that the timer count exceeds the predetermined time (NO in step ST1), the CPU 6 determines that the verification result is NG (step ST4). Then, the CPU 6 ends the process (END).

In other words, if the response codes match and if the authentication process time is within the predetermined time, the CPU 6 determines that the verification result is OK, namely, that the authentication chip slave 20 is the genuine chip. Otherwise, the CPU 6 determines that the chip slave 20 is not the genuine one.

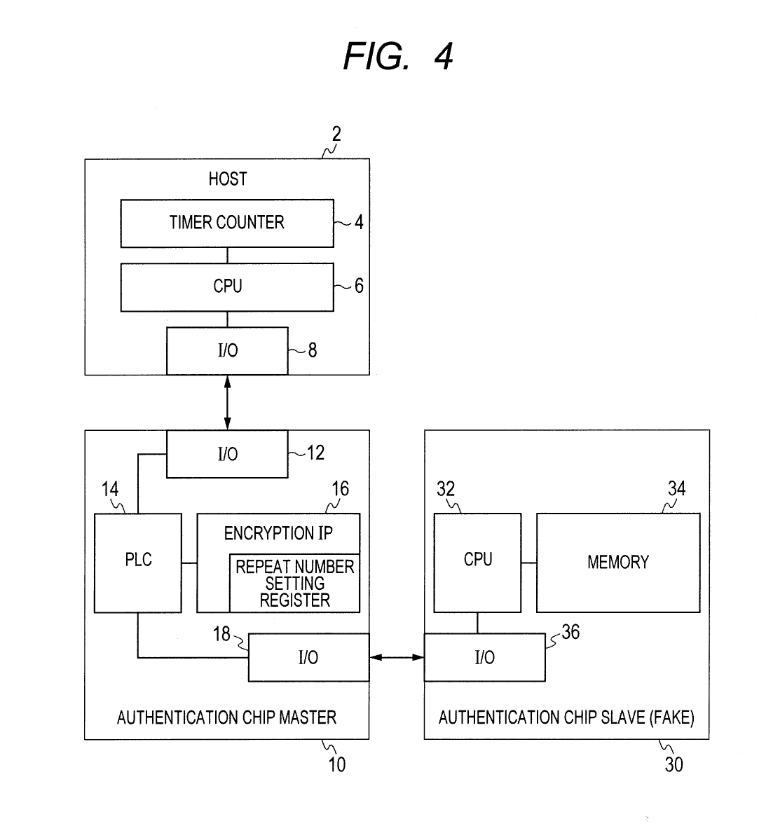

FIG. 4 is a diagram showing the authentication system with a fake chip as a comparative example. Referring to FIG. 4, the authentication system is different from the authentication system of FIG. 1 in that the authentication chip slave (genuine) 20 is replaced with an authentication chip slave (fake) 30.

The authentication chip master 10 and the authentication chip slave 20, according to the embodiment of the present invention, have a simple structure including the PLC, the encryption IP, and the I/Os. Thus, there is a risk that the particular authentication chip could be analyzed to make a fake.

As an example, the authentication chip slave (fake) 30 is made by emulating the authentication chip slave (genuine) 20 by software using a general-purpose microcomputer (CPU).

The authentication chip slave (fake) 30 includes a CPU 32, a memory 34, and an I/O 36. The memory 34 and the I/O 36 are coupled to the CPU 32, respectively.

It is assumed that the memory 34 stores a program that can perform a predetermined encryption process that is executed by the encryption IP 24 described in FIG. 1. It is also assumed that the CPU 32 can execute the same process as the encryption IP 24 described in FIG. 1, by reading and executing the program.

The authentication process described in FIG. 2 is performed even if the authentication chip slave (fake) 30 is used. More specifically, the authentication chip slave (fake) 30 can receive a challenge code from the authentication chip master 10, perform a predetermined encryption process multiple times with respect to the challenge code, and output a response code obtained as the result of the encryption process to the authentication chip master 10. In other words, even if the authentication chip slave (fake) 30 is used, it is possible to output the corresponding response code to the authentication chip master 10.

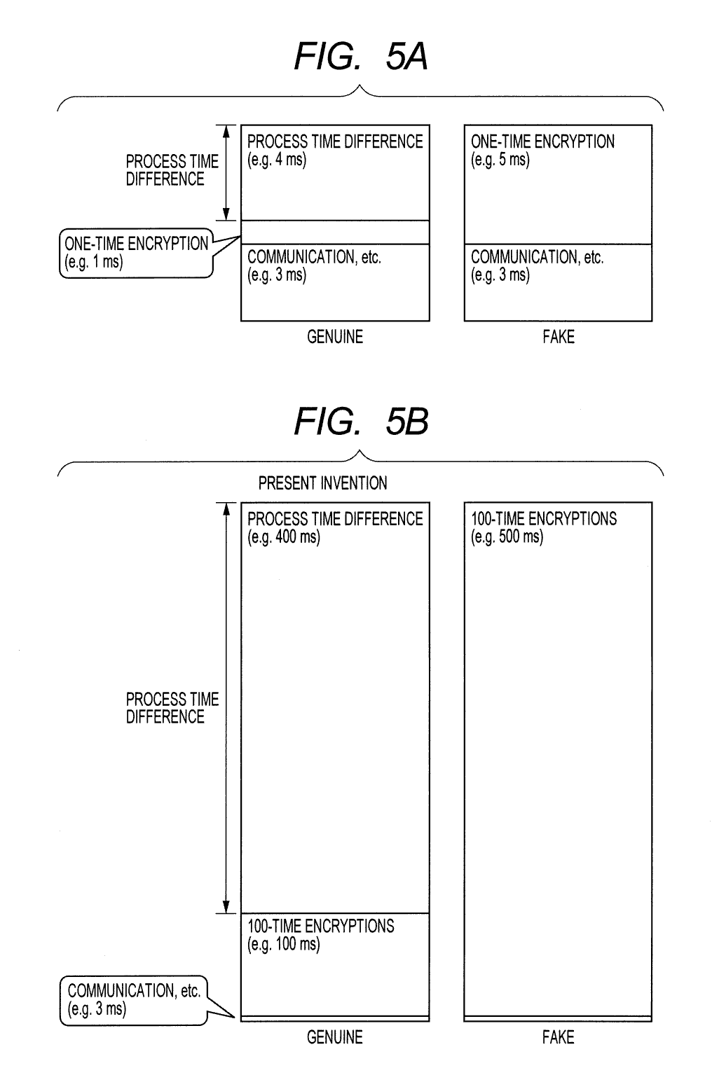

FIGS. 5A and 5B are diagrams showing the comparison of the authentication process time with the difference between the authentication chip slave (genuine) 20 and the authentication chip slave (fake) 30 according to the embodiment of the present invention.

In the authentication process based on the challenge and response mechanism using a general encryption process, a predetermined encryption process is often performed only once.

Referring to FIG. 5A, as an example, it is shown the authentication process time when a predetermined encryption process is performed once in the authentication chip slave (genuine) 20 and in the authentication chip slave (fake) 30.

The authentication process time can be roughly divided into two parts: the process time such as communication and determination, and the encryption process time.

In the case of the authentication chip slave (genuine) 20 described in FIG. 1, as an example, the process time such as communication and determination is 3 ms. Further, the encryption IP 24 is configured by hardware and the encryption process time of the encryption IP 24 is fast. As an example, it is shown that the time for performing one-time encryption process is 1 ms.

In the case of the authentication chip slave (fake) 30, as an example, the process time such as communication and determination is 3 ms. Further, as an example, the time for performing one-time encryption process is 5 ms. In this case, the function equivalent to the encryption IP 24 is realized when the CPU 32 reads the program stored in the memory 34. Thus, it takes some time for the CPU 32 to read the program and perform arithmetic operations and the like.

In FIG. 5A, as an example, it is shown that the difference in the process time is about 4 ms. In this example, the number of times the encryption process is performed is one. The proportion of the process time, such as communication and determination, to the total authentication process time is high, while the proportion of the encryption process time to the total authentication process time is small. Thus, the difference in the authentication process time (difference in the encryption process time) between the authentication chip slave (genuine) 20 and the authentication chip slave (fake) 30 is not very large. When taking into account the delay or other time constraint, it is very likely to be difficult to adequately distinguish between the authentication chip slave (genuine) 20 and the authentication chip slave (fake) 30 by the difference in the process time between the two authentication chip slaves.

Thus, the authentication system according to the embodiment of the present invention performs a predetermined encryption process multiple times as the authentication process.

Referring to FIG. 5B, as an example, it is shown the authentication process time when a predetermined encryption process is performed 100 times in the authentication chip slave (genuine) 20 and in the authentication chip slave (fake) 30.

The authentication process time is roughly divided into two parts: the process time such as communication and determination, and the encryption process time.

As described above, in the case of the authentication chip slave (genuine) 20 shown in FIG. 1, it is shown as an example that the process time such as communication and determination is 3 ms. Further, the encryption IP 24 is configured by hardware, and as an example, it is shown that the time for performing the encryption process 100 times is 100 ms.

On the other hand, in the case of the authentication chip slave (fake) 30, as described above, the process time such as communication and determination is 3 ms. The CPU 32 emulates the encryption IP 24 by the program stored in the memory 34, and as an example, it is shown that the time for performing a predetermined encryption process 100 times is 500 ms.

Thus, the process time difference is about 400 ms. In this example, the number of times the encryption process is performed is 100, so that the proportion of the encryption process time to the total authentication process time is high. As a result, the difference in the encryption process time between the authentication chip slave (genuine) 20 and the authentication chip slave (fake) 30, can directly affect the authentication process time significantly.

In this example, the difference in the authentication process time is about 400 ms. As an example, a threshold is set to a predetermined time of 200 ms in order to verify the difference in the authentication process time. In this way, it is possible to adequately distinguish between the authentication chip slave (genuine) 20 and the authentication chip slave (fake) 30 based on the difference in the authentication process time.

As described above, the authentication system according to the first embodiment of the present invention determines that the particular authentication chip slave is the genuine chip if the authentication process time is within the predetermined time, and otherwise that the particular authentication chip slave is the fake one, by taking into account not only the authentication result between the authentication chip master and the authentication chip slave 20, but also the authentication process time. In this way, highly accurate distinction can be achieved.

Note that in the embodiment of the present invention, as an example, the encryption process (sequence S5) in the authentication chip master 10 is performed between sequence S4 and sequence S8. However, the present invention is not limited to this example. The encryption process (sequence S5) in the authentication chip master 10 may also be performed between sequence S8 and sequence S9.

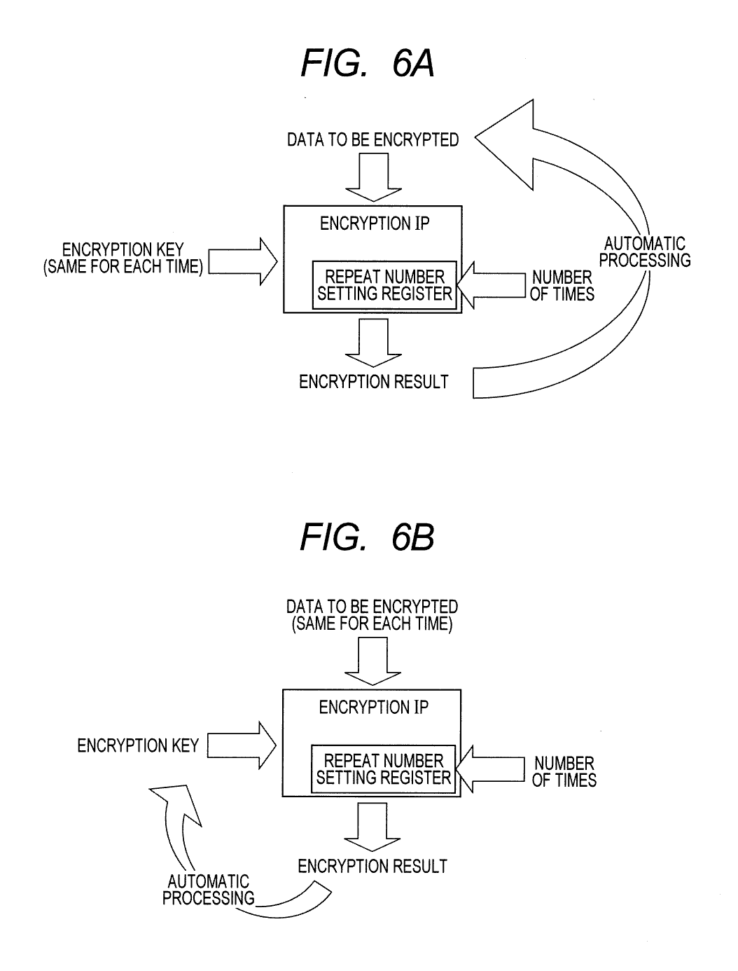

FIGS. 6A and 6B are conceptual diagrams each showing an encryption process method according to the embodiment of the present invention. Referring to FIG. 6A, it is shown that the encryption process is repeatedly performed in the encryption IP 24.

Here, the encryption IP 24 includes a repeat number setting register for setting the number of times the encryption process is repeated (the repeat number). It is assumed that the number of times the encryption process is performed is set according to the number input to the repeat number setting register. The number set in the repeat number setting register may be determined in advance as a fixed value, or may be input from the outside so that the value can be changed. In this example, it is assumed that the repeat number is more than one.

The encryption IP 24 performs the encryption process with respect to the input data by using a predetermined encryption key. Then, the result of the encryption process is fed back to the input side again according to the number set in the repeat number setting register. In this way, the encryption process can be performed multiple times.

FIG. 6B is a conceptual diagram showing another encryption process. Here, it is assumed that the data to be encrypted and the encryption key have the same data length.

When the data length is the same, it is possible to perform the encryption process multiple times by feeding back the encryption result as the encryption key, instead of feeding back the encryption result as the data to be encrypted.

First, the encryption IP 24 performs the encryption process with respect to the input data by using a predetermined encryption key. Then, the encryption IP 24 performs the encryption process with respect to the input data by means of the result of the encryption process as the encryption key. The result of the encryption process is fed back to the encryption key side based on the number set in the repeat number setting register. In this way, the encryption process can be performed multiple times.

### First Variation of the First Embodiment

In the first embodiment described above, the predetermined encryption process is performed multiple times in the encryption IP in response to the authentication start execution instruction. However, it is also possible that the predetermined encryption process is performed multiple times only when a predetermined command is input. In this case, the normal encryption process (one time encryption process) can be performed when the command is not input.

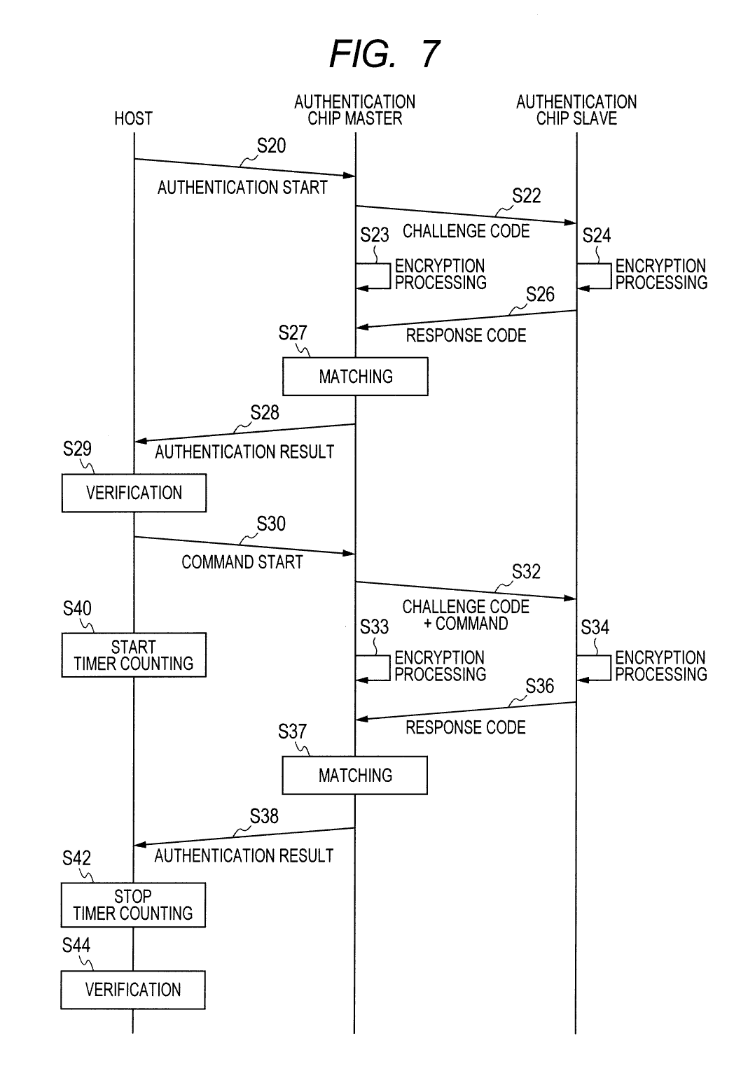

FIG. 7 is a sequence diagram of the flow of the authentication system according to the first variation of the first embodiment of the present invention.

Referring to FIG. 7, the host 2 instructs the authentication chip master 10 to start authentication (sequence S20). More specifically, the CPU 6 instructs the PLC 14 of the authentication chip master 10 through the I/O 8 to execute the authentication start.

In response to the authentication start execution instruction from the host 2, the PLC 14 of the authentication chip master 10 outputs a challenge code to the authentication chip slave 20 (sequence S22). As an example, the challenge code may be selected from random numbers or may be fixed in advance.

Next, the authentication chip slave 20 performs an encryption process with respect to the challenge code received from the authentication chip master 10 (sequence S24). More specifically, the PLC 22 of the authentication chip slave 20 receives the challenge code output from the authentication chip master 10 through the I/O 26. Then, the PLC 22 of the authentication chip slave 20 outputs the challenge code to the encryption IP 24. The encryption IP 24 performs a predetermined encryption process once with respect to the challenge code output from the PLC 22.

Then, the authentication chip slave 20 outputs a response code obtained as the result of the encryption process to the authentication chip master 10 (sequence S26). More specifically, the PLC 22 outputs the result (response code) of the encryption process performed in the encryption IP 24 with respect to the challenge code, to the authentication chip master 10 through the I/O 26.

At the same time, the authentication chip master 10 performs an encryption process with respect to the challenge code (sequence S23). More specifically, the PLC 14 outputs the challenge code to the encryption IP 16. Then, the encryption IP 16 performs a predetermined encryption process once with respect to the challenge code.

Then, the authentication chip master 10 performs a response code matching process (sequence S27). More specifically, the PLC 14 compares the response code output from the authentication chip slave 20 as the result of the encryption process performed in the encryption IP 24 with respect to the challenge code, with the result (response code) of the encryption process performed in the encryption IP 16 with respect to the challenge code. In this way, the PLC 14 determines whether the two response codes match or not.

Then, the authentication chip master 10 outputs the authentication result to the host 2 (sequence S28). More specifically, the PLC 14 outputs the determination result of either match or not match to the CPU 6 of the host 2.

The CPU 6 performs verification based on the authentication result from the authentication chip master 10 (sequence S29). More specifically, if the two response codes match, the CPU 6 proceeds to the next step, and if not match, the CPU 6 ends the process.

If the response codes match as the authentication result, the CPU 6 of the host 2 then outputs a predetermined command, which is a process command to further distinguish between genuine and fake. In response to the predetermined command, the authentication chip master 10 and the authentication chip slave 20 perform a predetermined encryption process multiple times.

Further, in conjunction with the output of the predetermined command, the CPU 6 of the host 2 instructs the timer counter 4 to start timer counting (sequence S40). In this way, the time is measured.

In response to the input of the predetermined command from the host 2, the PLC 14 of the authentication chip master 10 outputs the challenge code and predetermined command to the authentication chip slave 20 (sequence S32). As an example, the challenge code may be selected from random numbers or may be fixed in advance.

Next, the authentication chip slave 20 performs an encryption process with respect to the challenge code received from the authentication chip master 10 (sequence S34). More specifically, the PLC 22 of the authentication chip slave 20 receives the challenge code and command output from the authentication chip master 10 through the I/O 26. Then, the PLC 22 outputs the challenge code and the predetermined command to the encryption IP 24. In response to the predetermined command, the encryption IP 24 performs a predetermined encryption process multiple times with respect to the challenge code output from the PLC 22.

Then, the authentication chip slave 20 outputs a response code obtained as the result of the encryption process to the authentication chip master 10 (sequence S36). More specifically, the PLC 22 outputs the result (response code) of the encryption process performed in the encryption IP 24 with respect to the challenge code, to the authentication chip master 10 through the I/O 26.

At the same time, the authentication chip master 10 performs an encryption process with respect to the challenge code (sequence S33). More specifically, the PLC 14 outputs the challenge code and the predetermined command to the encryption IP 16. In response to the predetermined command, the encryption IP 16 performs a predetermined encryption process multiple times with respect to the challenge code.

Then, the authentication chip master 10 performs a response code matching process (sequence S37). More specifically, the PLC 14 compares the response code output from the authentication chip slave 20 as the result of the encryption process performed in the encryption IP 24 with respect to the challenge code, with the result (response code) of the encryption process performed in the encryption IP 16 with respect to the challenge code. In this way, the authentication chip master 10 determines whether the two response codes match or not.

Then, the authentication chip master 10 outputs the authentication result to the host 2 (sequence S38). More specifically, the PLC 14 outputs the determination result of either match or not match to the CPU 6 of the host 2.

In response to the authentication result from the authentication chip master 10, the CPU 6 stops timer counting (sequence S42). More specifically, the CPU 6 instructs the timer counter 4 to obtain the counter value which is the authentication process time from the start of the execution of the authentication process until the authentication result is obtained.

Then, the CPU 6 performs a verification process (sequence S44). More specifically, the CPU 6 checks whether the authentication chip slave 20 is the genuine or not based on the authentication result and the authentication process time.

Also in the authentication system according to the first variation of the first embodiment, as described above, if the authentication chip slave (fake) 30 is used, it is possible to determine that the particular authentication chip slave is genuine if the authentication process time is within the predetermined time, and otherwise that the particular authentication chip slave is the fake one, by taking into account not only the authentication result between the authentication chip master 10 and the authentication chip slave 20, but also the authentication process time. In this way, highly accurate distinction can be achieved.

Further, in this example, the first verification is performed in step S29 to check whether the two response codes match or not. At this time, this allows the authentication system to determine, for example, that the authentication is successful. Then, a more accurate verification can be performed using the predetermined command to check whether the particular authentication chip slave is fake or not.

In the first embodiment, the encryption process is performed multiple times by using the encryption IP. Thus, it may take a longtime from the completion of the final check until the authentication is successful. The start-up process of the other function, and the like, is performed after the success of the authentication process. For this reason, a quick start-up may not be done even if the genuine chip is used. However, in the case of the first variation of the first embodiment, the verification process is divided into two stages in order to achieve a quick start-up process, and the like, by reducing the time of the first verification stage to allow the authentication system to determine the authentication success earlier. Then, in parallel with this, the second verification is performed to accurately determine whether the authentication chip slave is the genuine or not. For example, if it is determined that the authentication chip slave is the fake one, a restriction may be applied to the function or a shut-down or other process may be performed.

### Second Variation of the First Embodiment

As described above, in the first variation of the first embodiment, the encryption process is performed multiple times when the predetermined command is input. In a second variation of the first embodiment, the predetermined command includes the information on the number of times the encryption process is performed.

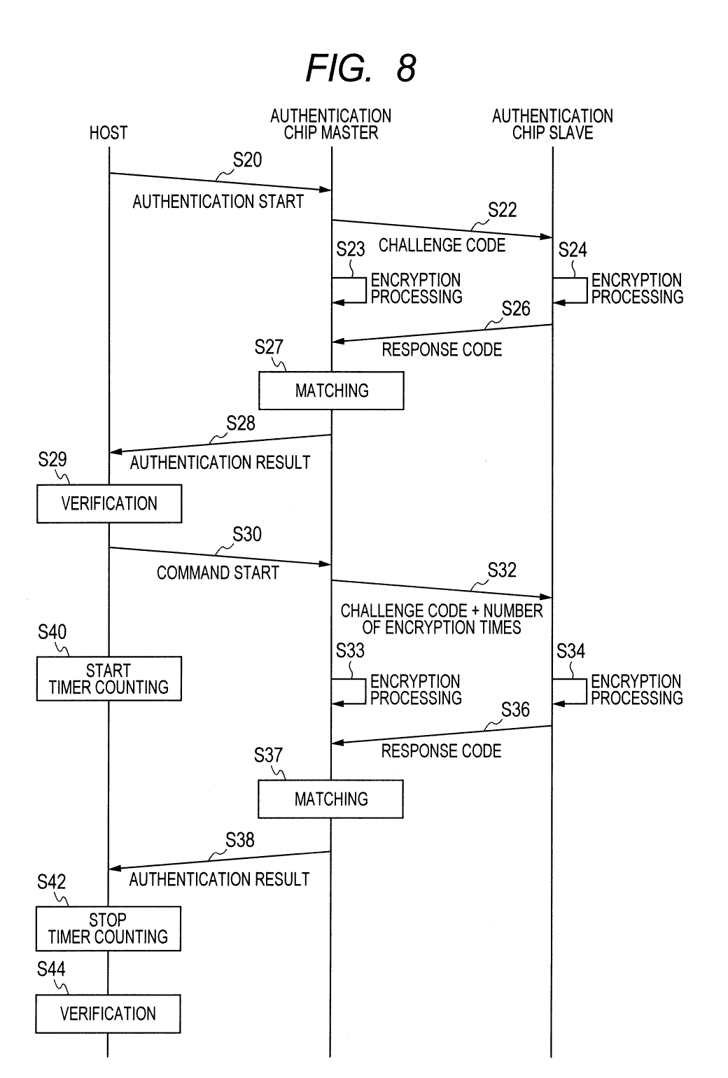

FIG. 8 is a sequence diagram of the flow of the authentication process in the authentication system according to the second variation of the first embodiment of the present invention.

Referring to FIG. 8, the host 2 instructs the authentication chip master 10 to start authentication (sequence S20). More specifically, the CPU 6 instructs the PLC 14 of the authentication chip master 10 through the I/O 8 to execute the authentication start.

In response to the authentication start execution instruction from the host 2, the PLC 14 of the authentication chip master 10 outputs a challenge code to the authentication chip slave 20 (sequence S22). As an example, the challenge code may be selected from random numbers or may be fixed in advance.

Next, the authentication chip slave 20 performs an encryption process with respect to the challenge code received from the authentication chip master 10 (sequence S24). More specifically, the PLC 22 of the authentication chip slave 20 receives the challenge code output from the authentication chip master 10 through the I/O 26. Then, the PLC 22 outputs the challenge code to the encryption IP 24. The encryption IP 24 performs a predetermined encryption process once with respect to the challenge code output from the PLC 22. In this case, the number of encryption times is not input to the encryption IP 24. However, it is assumed that the encryption process is performed once as the default value.

Then, the authentication chip slave 20 outputs a response code obtained as the result of the encryption process to the authentication chip master 10 (sequence S26). More specifically, the PLC 22 outputs the result (response code) of the encryption process performed in the encryption IP 24 with respect to the challenge code, to the authentication chip master 10 through the I/O 26.

At the same time, the authentication chip master 10 performs an encryption process with respect to the challenge code (sequence S23). More specifically, the PLC 14 outputs the challenge code to the encryption IP 16. Then, the encryption IP 16 performs a predetermined encryption process once with respect to the challenge code.

Then, the authentication chip master 10 performs a response code matching process (sequence S27). More specifically, the PLC 14 compares the response code output from the authentication chip slave 20 as the result of the encryption process performed in the encryption IP 24 with respect to the challenge code, with the result (response code) of the encryption process performed in the encryption IP 16 with respect to the challenge code. In this way, the PLC 14 determines whether the two response codes match or not.

Then, the authentication chip master 10 outputs the authentication result to the host 2 (sequence S28). More specifically, the PLC 14 outputs the determination result of either match or not match to the CPU 6 of the host 2.

The CPU 6 performs verification based on the authentication result from the authentication chip master 10 (sequence S29). More specifically, if the two response codes match, the CPU 6 proceeds to the next step, and otherwise ends the process.

If the two response codes match as the authentication result, then the CPU 6 of the host 2 outputs a predetermined command, which is a process command to further distinguish between genuine and fake. It is assumed that the predetermined command includes the information on the number of times the encryption process is performed (the number of encryption times). It is also assumed that the authentication chip master and the authentication chip slave 20 perform the predetermined encryption process multiple times according to the number of encryption times.

Further, in conjunction with the output of the predetermined command, the CPU 6 of the host 2 instructs the timer counter 4 to start timer counting (sequence S40). In this way, the time is measured.

In response to the input of the predetermined command from the host 2, the PLC 14 of the authentication chip master 10 outputs a challenge code and the number of encryption times to the authentication chip slave 20 (sequence S32). As an example, the challenge code may be selected from random numbers or may be fixed in advance.

Next, the authentication chip slave 20 performs an encryption process with respect to the challenge code received from the authentication chip master 10 (sequence S34). More specifically, the PLC 22 of the authentication chip slave 20 receives the challenge code and the number of encryption times, which are output from the authentication chip master 10 through the I/O 26. Then, the PLC 22 outputs the challenge code and the number of encryption times to the encryption IP 24. The encryption IP 24 performs a predetermined encryption process multiple times with respect to the challenge code output from the PLC 22, according to the number of encryption times.

Then, the authentication chip slave 20 outputs a response code obtained as the result of the encryption process to the authentication chip master 10 (sequence S36). More specifically, the PLC 22 outputs the result (response code) of the encryption process performed in the encryption IP 24 with respect to the challenge code, to the authentication chip master 10 through the I/O 26.

At the same time, the authentication chip master 10 performs an encryption process with respect to the challenge code (sequence S33). More specifically, the PLC 14 outputs the challenge code and the number of encryption times to the encryption IP 16. Then, the encryption IP 16 performs a predetermined encryption process multiple times with respect to the challenge code, according to the number of encryption times.

Then, the authentication chip master 10 performs a response code matching process (sequence S37). More specifically, the PLC 14 compares the response code output from the authentication chip slave 20 as the result of the encryption process performed in the encryption IP 24 with respect to the challenge code, with the result (response code) of the encryption process performed in the encryption IP 16 with respect to the challenge code. In this way, the PLC 14 determines whether the two response codes match or not.

Then, the authentication chip master 10 outputs the authentication result to the host 2 (sequence S38). More specifically, the PLC 14 outputs the determination result of either match or not match to the CPU 6 of the host 2.

In response to the authentication result from the authentication chip master 10, the CPU 6 stops timer counting (sequence S42). More specifically, the CPU 6 instructs the timer counter 4 to obtain the counter value which is the authentication process time from the start of the execution of the authentication process until the authentication result is obtained.

Then, the CPU 6 performs a verification process (sequence S44). More specifically, the CPU 6 checks whether the authentication chip slave 20 is the genuine or not, based on the authentication result and the authentication process time.

Also in the authentication system according to the second variation of the first embodiment, as described above, if the authentication chip slave (fake) 30 is used, it is possible to determine that the particular authentication chip slave is the genuine chip if the authentication process time is within the predetermined time, and otherwise that the particular authentication chip is the fake one, by taking into account not only the authentication result between the authentication chip master 10 and the authentication chip slave 20, but also the authentication process time. In this way, highly accurate distinction can be achieved.

Further, in this example, the first verification is performed in step S29 to check whether the two response codes match or not. At this time, this allows the authentication system to determine, for example, that the authentication is successful. Then, a more accurate verification can be performed using the predetermined command to check whether the particular authentication chip slave is fake or not.

In this example, the predetermined command includes the number of times the encryption process is performed (the number of encryption times), in order to adjust the encryption process time by changing the number of encryption times.

### Second Embodiment

In the first embodiment, as described above, the encryption process is performed both in the authentication chip master 10 and in the authentication chip slave 20 with respect to the challenge code. However, the present invention is not necessarily limited to this, and is also applicable to the authentication method in which the encryption process result is decrypted in the authentication chip master.

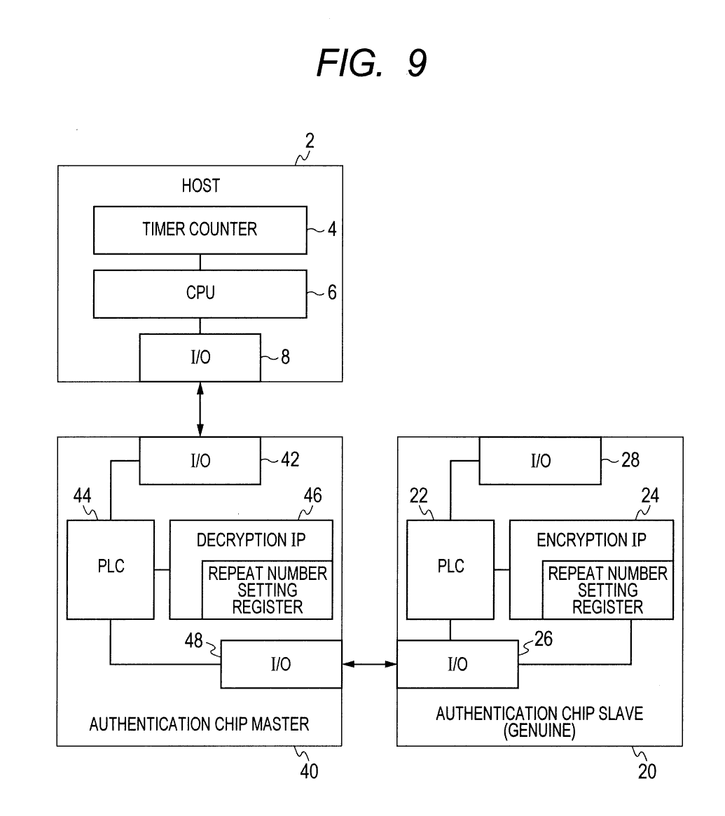

FIG. 9 is a schematic diagram of an authentication system according to the second embodiment of the present invention. Referring to FIG. 9, the authentication system according to the second embodiment of the present invention is different from the authentication system described with reference to FIG. 1 in that the authentication chip master 10 is replaced with an authentication chip master 40. The other configuration is the same and thus the detailed description thereof will not be repeated.

The authentication chip master 40 includes a programmable logic controller (PLC) 44, I/Os 42 and 48, and a decryption intellectual property (IP) 46. The I/Os 42, 48 and the decryption IP 46 are coupled to the PLC 44, respectively. The PLC 44 is designed to function as a controller to control the authentication chip master 40. The I/O 42 is coupled to the I/O 8 and transfers data between the host 2 and the authentication chip master 40. The I/O 48 is coupled to the I/O 26 and transfers data between the authentication chip master 40 and the authentication chip slave 20. The decryption IP 46 is designed to be able to perform a predetermined description process multiple times.

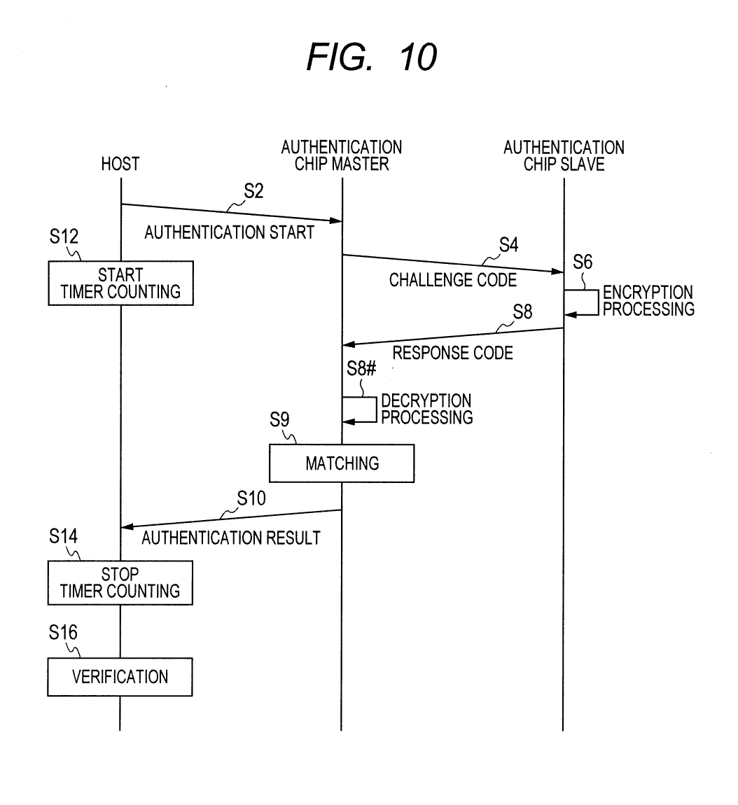

FIG. 10 is a sequence diagram of the flow of the authentication process in the authentication system according to the second embodiment of the present invention.

Here, the authentication process based on the challenge and response mechanism using encryption process will be described.

Referring to FIG. 10, the host 2 instructs the authentication chip master 40 to start authentication (sequence S2). More specifically, the CPU 6 of the host 2 instructs the PLC 44 of the authentication chip master 40 through the I/O 8 to execute the authentication start.

Further, in conjunction with the authentication start execution instruction, the CPU 6 of the host 2 instructs the timer counter 4 to start timer counting (sequence S12). In this way, the time during the authentication process is measured.

In response to the authentication start execution instruction from the host 2, the PLC 44 of the authentication chip master 40 outputs a challenge code to the authentication chip slave 20 (sequence S4). As an example, the challenge code may be selected from random numbers or may be fixed in advance.

Next, the authentication chip slave 20 performs an encryption process with respect to the challenge code received from the authentication chip master 40 (sequence S6). More specifically, the PLC 22 of the authentication chip slave 20 receives the challenge code output from the authentication chip master 40 through the I/O 26. Then, the PLC 22 outputs the challenge code to the encryption IP 24. The encryption IP 24 performs a predetermined encryption process multiple times with respect to the challenge code output from the PLC 22.

Then, the authentication chip slave 20 outputs a response code obtained as the result of the encryption process, to the authentication chip master 40 (sequence S8). More specifically, the PLC 22 outputs the result (response code) of the encryption process performed in the encryption IP 24 with respect to the challenge code, to the authentication chip master 40 through the I/O 26.

At the same time, the authentication chip master 40 performs a decryption process with respect to the challenge code (sequence S8#). More specifically, the PLC 44 outputs the challenge code to the decryption IP 46. Then, the decryption IP 46 performs a predetermined decryption process multiple times with respect to the challenge code.

Then, the authentication chip master 40 performs a response code matching process (sequence S9). More specifically, the PLC 44 compares the output challenge code with the response code (challenge code) obtained as the result of the decryption process in the description IP 46. In this way, the PLC 44 determines whether the output challenge code matches the decrypted response code (challenge code).

Then, the authentication chip master 40 outputs the authentication result to the host 2 (sequence S10). More specifically, the PLC 44 outputs the determination result of either match or not match to the CPU 6 of the host 2.

In response to the authentication result from the authentication chip master 40, the CPU 6 stops timer counting (sequence S14). More specifically, the CPU 6 instructs the timer counter 4 to obtain the counter value which is the authentication process time from the start of the execution of the authentication process until the authentication result is obtained.

Then, the CPU 6 performs a verification process (sequence S16). More specifically, the CPU 6 checks whether the authentication chip slave 20 is the genuine or not, based on the authentication result and the authentication process time.

Also in the authentication system according to the second embodiment of the present invention, as described above, if the authentication chip slave (fake) 30 is used, it is possible to determine that the particular authentication chip slave is the genuine chip if the authentication process time is within the predetermined time, and otherwise that the particular authentication chip slave is the fake one, by taking into account not only the authentication result between the authentication chip master 40 and the authentication chip slave 20, but also the authentication process time. In this way, highly accurate distinction can be achieved.

In the above embodiments, it is assumed that the host 2, and the authentication chip master 10 or 40 are configured as independent chips. However, the present invention is not necessarily limited to this configuration. It is possible that the host 2 and the authentication chip master 10 or 40 are configured as the same chip. In this case, the PLC 14 or 44 can be directly coupled to the CPU 6 without specifically providing the I/Os 8, 12, and 42. Further, it is also possible that instead of providing the PLC 14 or 44, the function of the PLC 14 or 44 is executed by the CPU 6.

Further, for example, the host 2 and the authentication chip master 10 or 40 may be loaded into a battery charger while the authentication chip slave 20 may be loaded into a rechargeable battery, to perform an authentication process between the battery charger and the rechargeable battery. Alternatively, the host 2 and the authentication chip master 10 or 40 may be loaded into the body of an image forming device while the authentication chip slave 20 may be loaded into a consumable tonner cartridge of the image forming device, to perform an authentication process between the body of the image forming device and the tonner cartridge. However, the present invention is not limited to the above examples. It is also possible to implement the authentication system according to the embodiments of the present invention in combination with other devices or parts.

The embodiments disclosed herein are to be considered in all respects as illustrative and not restrictive. The scope of the present invention is indicated by the appended claims, rather than by the foregoing description, and all changes which come within the meaning and range of equivalency of the claims are therefore intended to be embraced therein.

What is claimed is:

1. An authentication system comprising:
a body chip; and
a sub chip coupled to the body chip to perform an authentication process with the body chip,
wherein the sub chip includes a first encryption processing unit for performing an encryption process multiple times in response to an authentication execution instruction from the body chip, and then outputting the result of the encryption process to the body chip,
wherein the body chip includes an authentication determination unit for determining whether the sub chip is valid or not, based on the result of the encryption process received from the sub chip, and on the time from the authentication execution instruction until the result is obtained.

2. The authentication system according to claim 1,
wherein the body chip includes:
a second encryption processing unit capable of performing an encryption process multiple times; and
a timer for measuring the authentication time,
wherein the authentication determination unit outputs a challenge code to the first and second encryption processing units as the authentication execution instruction,
wherein the first and second encryption processing units perform the encryption process multiple times with respect to the challenge code, and output first and second response codes as the results of the encryption processes, respectively, to the authentication determination unit,
wherein the authentication determination unit determines whether the first and second response codes match or not,
wherein if the first and second response codes match, the authentication determination unit determines whether the authentication time measured by the timer is within a predetermine time,
wherein if the authentication time is within the predetermined time, the authentication determination unit determines that the sub chip is valid.

3. The authentication system according to claim 1,
wherein the body chip includes:
a second encryption processing unit capable of performing an encryption process multiple times; and
a timer for measuring the authentication time,
wherein the authentication determination unit outputs a first challenge code to the first and second encryption processing units as the authentication execution instruction,
wherein the first and second encryption processing units perform one-time encryption process with respect to the first challenge code, and output first and second respond codes as the results of the encryption processes, respectively, to the authentication determination unit,
wherein the authentication determination unit determines whether the first and second response codes match or not,
wherein if the first and second response codes match, the authentication determination unit outputs a second challenge code to the first and second encryption processing units,
wherein the first and second encryption processing units perform the encryption process multiple times with respect to the second challenge code, and output third and fourth response codes as the results of the encryption processes, respectively, to the authentication determination unit,
wherein the authentication determination unit determines whether the third and fourth response codes match or not,
wherein if the third and fourth response codes match, the authentication determination unit determines whether the authentication time measured by the timer is within a predetermined time,
wherein if the authentication time is within the predetermined time, the authentication determination unit determines that the sub chip is valid.

4. The authentication system according to claim 1,
wherein the body chip includes:
a second encryption processing unit capable of performing an encryption process multiple times; and
a timer for measuring the authentication time,
wherein the authentication determination unit outputs a first challenge code to the first and second encryption processing units as the authentication execution instruction,
wherein the first and second encryption processing units perform one-time encryption process with respect to the first challenge code, and output first and second response codes as the results of the encryption processes, respectively, to the authentication determination unit,
wherein the authentication determination unit determines whether the first and second response codes match or not,
wherein if the first and second response codes match, the authentication determination unit outputs a second challenge code as well as information on the number of times the encryption process is performed, to the first and second encryption processing units,
wherein the first and second encryption processing units repeat the encryption process for the number of times specified in the number of times information, with respect to the second challenge code, and output third and fourth response codes as the results of the encryption processes, respectively, to the authentication determination unit,
wherein the authentication determination unit determines whether the third and fourth response codes match or not,
wherein if the third and fourth response codes match, the authentication determination unit determines whether the authentication time measured by the timer is within a predetermined time,
wherein if the authentication time is within the predetermined time, the authentication determination unit determines that the sub chip is valid.

5. The authentication system according to claim 1,
wherein the body chip includes:
a decryption processing unit capable of performing a decryption process multiple times; and
a timer for measuring the authentication time,
wherein the authentication determination unit outputs a challenge code to the first encryption processing unit as the authentication execution instruction,
wherein the first encryption processing unit performs the encryption process multiple times with respect to the challenge code, and then outputs a first response code to the decryption processing unit,
wherein the decryption processing unit performs the decryption process multiple times with respect to the first response code, and then outputs a second response code to the authentication determination unit,
wherein the authentication determination unit determines whether the challenge code and the second response code match or not,
wherein if the challenge code and the second response code match each other, the authentication determination unit determines whether the authentication time measured by the timer is within a predetermined time,
wherein if the authentication time is within the predetermined time, the authentication determination unit determines that the sub chip is valid.
